(19) United States
(12) Patent Application Publication
(10) Pub. No.: US 2008/0205846 A1
(43) Pub. Date: Aug. 28, 2008

(54) Method and System for Presenting Information Relating to Recorded Content

(76) Inventors: Eric H. Lee, San Jose, CA (US); David C. Lee, Sunnyvale, CA (US); Fadi R. Jabbour, Sunnyvale, CA (US); Johnny H. Lee, San Gabriel, CA (US)

Correspondence Address: BAKER BOTTS L.L.P., 2001 ROSS AVENUE, SUITE 600, DALLAS, TX, 75201-2980, US

(21) Appl. No.: 11/679,023

(22) Filed: Feb. 26, 2007

(51) Int. Cl. H04N 5/91

(52) U.S. Cl. 386/46; 386/68

(57) ABSTRACT

A method for presenting information includes receiving an instruction to present recorded content and presenting the recorded content on a display. The method includes monitoring data associated with the recorded content and receiving an instruction to present the recorded content at a fast forward speed. The method also includes presenting the recorded content at the fast forward speed on the display and, while presenting the recorded content at the fast forward speed, presenting on the display information about the subject matter of the recorded content presented at the fast forward speed based on the data associated with the recorded content.

### TECHNICAL FIELD OF THE INVENTION

The present invention relates generally to communication systems and, more particularly, to a method and system for presenting information relating to recorded content.

### BACKGROUND

An increasing number of television viewers are utilizing personal video recorders (PVRs) to watch television programs. The PVRs enable viewers to watch recorded television content and, in many cases, to fast forward through aspects of the content such as commercials. Many viewers will fast forward any commercial segments that are part of recorded content so that a show can be viewed more quickly. Thus, in some respects, television commercials are becoming less effective as an advertisement mechanism.

### SUMMARY

The present invention provides a method and system for presenting information relating to recorded content that substantially eliminates or reduces at least some of the disadvantages and problems associated with previous methods and systems.

In accordance with a particular embodiment, a method for presenting information includes receiving an instruction to present recorded content and presenting the recorded content on a display. The method includes monitoring data associated with the recorded content and receiving an instruction to present the recorded content at a fast forward speed. The method also includes presenting the recorded content at the fast forward speed on the display and, while presenting the recorded content at the fast forward speed, presenting on the display information about the subject matter of the recorded content presented at the fast forward speed based on the data associated with the recorded content.

The recorded content presented at the fast forward speed may comprise advertisement content, and the information about the subject matter of the recorded content presented at the fast forward speed may comprise information about the advertisement content. The information about the subject matter of the recorded content presented at the fast forward speed may comprise textual information about the advertisement content or graphical information about the advertisement content. The method may include receiving an instruction to view at a normal speed the advertisement content presented at the fast forward speed and presenting on the display the advertisement content at the normal speed. The data associated with the recorded content may comprise closed captioning data or MPEG data. The method may include receiving communications comprising video content and recording the video content as recorded content.

In accordance with another embodiment, a system for presenting information includes an interface operable to receive an instruction to present recorded content and a processor coupled to the interface and operable to present the recorded content on a display and monitor data associated with the recorded content. The interface is further operable to receive an instruction to present the recorded content at a fast forward speed. The processor is further operable to present the recorded content at the fast forward speed on the display and, while presenting the recorded content at the fast forward speed, present on the display information about the subject matter of the recorded content presented at the fast forward speed based on the data associated with the recorded content.

Technical advantages of particular embodiments include methods and systems that enable information from commercials and advertisements included in recorded television content to be provided to viewers, even when the viewers may be fast forwarding through the commercials and advertisements as they may have originally appeared in the recorded content. In particular embodiments, PVRs used to record the content and to enable viewers to fast forward and/or skip through portions of the content, including commercials and advertisements, may read data associated with the commercials and advertisements and textually or audibly present information about the commercials and advertisements for the viewers. Such presentation may take place before, during or after the fast forwarding or skipping of the commercials and advertisements. Accordingly, information from commercials and advertisements is presented in a more viewer-friendly way. In addition, despite viewers fast forwarding or skipping through recorded television content, advertisers will still be able to present relevant information about the advertisements in an effective manner.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 illustrates a communication system with a headend and a plurality of client systems, in accordance with a particular embodiment;

FIG. 2 illustrates a client system, in accordance with a particular embodiment;

FIG. 3 illustrates an example signal received by a client system such as the client system of FIG. 2, in accordance with a particular embodiment;

FIGS. 4A and 4B illustrate example screens of a display when particular embodiments are implemented; and

FIG. 5 is a flowchart illustrating a method for presenting information, in accordance with a particular embodiment.

### DETAILED DESCRIPTION

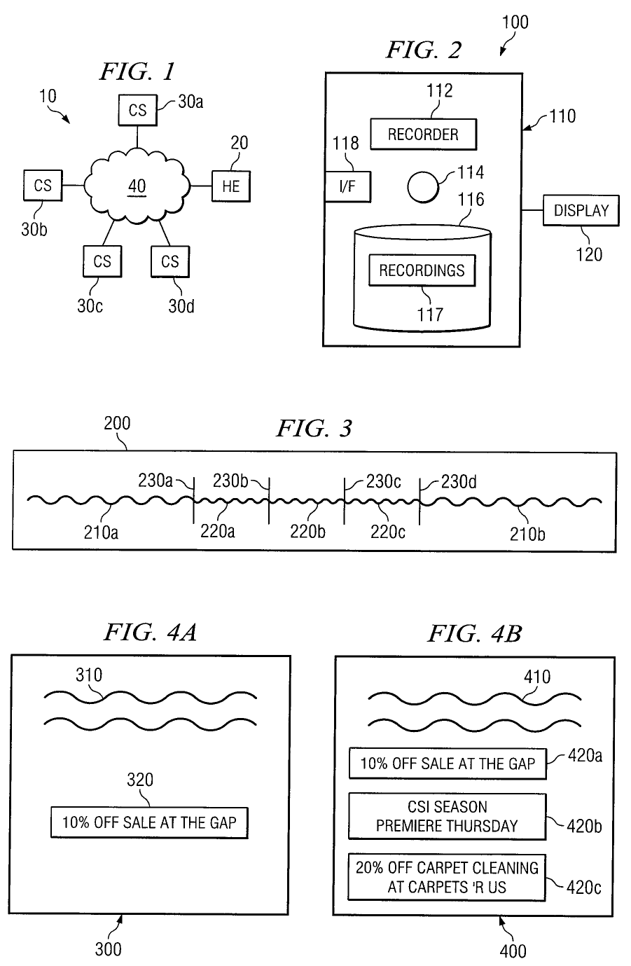

FIG. 1 illustrates a communication system 10, in accordance with a particular embodiment. Communication system 10 includes a headend 20 coupled for communication with client systems 30a-30d through communication network 40. Communications between headend 20 and client systems 30a-30d may be enabled by communication network 40 and/or other endpoints, components or resources coupled with communication network 40. Headend 20 may include any suitable hardware, software or encoded logic, such as one or more server devices, for providing broadband signals, such as video, audio and/or data signals, to client systems 30 via communication network 40. Headend 20 and client systems 30 may cooperate to provide a user with a variety of services, such as analog or digital broadcast television services and channels, video-on-demand (VOD) services and/or pay-per-view (PPV) services, among others. Each broadcast television channel typically provides a sequence of television presentations corresponding to a television station (e.g., ABC, NBC, CBS, or CNN) and is typically identified by a channel number (e.g., channel 2, channel 3, channel 4) that is available to a user at all times.

Particular embodiments enable information from commercials and advertisements included in content communicated from headend 20 to client systems 30 to be provided to viewers who have recorded the content, even when the viewers may be fast forwarding through the commercials and advertisements as they may have originally appeared in the recorded content. In particular embodiments, PVRs, for example at client systems 30, used to record the content and to enable viewers to fast forward and/or skip through portions of the content, including commercials and advertisements, may read data associated with the commercials and advertisements and textually or audibly present information about the commercials and advertisements for the viewers. Such presentation may take place before, during or after the fast forwarding or skipping of the commercials and advertisements. Accordingly, information from commercials and advertisements is presented in a more viewer-friendly way. In addition, despite viewers fast forwarding or skipping through recorded television content, advertisers will still be able to present relevant information about the advertisements in an effective manner.

Client systems 30a-30d may be any combination of hardware, software and/or encoded logic that provide communication services to a user. In some embodiments, client systems 30a-30d may include a set-top terminal (STT), a television, a computer, a personal digital assistant (PDA) or other display devices. Example client systems that may be used in particular embodiments are further discussed below. Although FIG. 1 illustrates four client systems 30a-30d, communication system 10 contemplates any number and arrangement of client systems 30 for communicating media and providing audio, video and other services to users.

In addition, although a specific communication network 40 is illustrated in FIG. 1, the term “communication network” should be interpreted as generically defining any network capable of transmitting audio and/or video telecommunications signals, data and/or messages, including broadband signals, such as video/audio, telephony, data or Internet Protocol (IP) signals. Communication network 40 may be any computer or communication network capable of coupling two or more components, such as headend 20 and client systems 30, for communication. In some embodiments, communication network 40 may include a hybrid fiber/coax (HFC) network, a fiber-to-the-home (FTTH) network, a satellite network or a fixed wireless network (e.g., MMDS). Communication network 40 may include a wide area network (WAN) that enables communication between a plurality of endpoints distributed across multiple cities and geographic regions and other networks, such as the Internet, the public switched telephone network, local area networks (LANs), global distributed networks such as intranets, extranets or other form of wireless or wireline communication networks. Communication network 40 may be coupled to client systems 30 and headend 20 through any suitable communication links, such as cable, satellite, wireless links, fiber or other links.

Communication paths for communications within communication network 40 may include any combination of routers, hubs, switches, gateways or other hardware, software or embedded logic implementing any number of communication protocols. Communication network 40 may support any form and combination of point-to-point, multicast, unicast or other techniques for exchanging media packets among components in communication system 10.

FIG. 2 illustrates a client system 100, in accordance with a particular embodiment. Client system 100 may be coupled to a headend, such as headend 20 of FIG. 1, or other communication system component(s) for receiving and transmitting audio and/or video signals, data and/or messages, including broadband signals, such as video/audio, telephony, data or Internet Protocol (IP) signals. Client system 100 may be coupled to such a headend or other communication system component(s) through one or more communication networks, such as those discussed with respect to communication system 10 of FIG. 1.

In the illustrated embodiment, client system 100 includes a client communication component 110 and a display component 120. Client communication component receives audio and video communications for presentation to a user at display component 120. Client communication component 110 also includes recording functionality to enable presentation of received audio and video communications to a user at a time later than when the communications are received. In some embodiments, client communication component 110 may include, or be known as, a personal digital recorder (PVR), a digital video recorder (DVR), a set top box (STB), a cable or satellite receiver or a combination of the foregoing. Display component 120 may include any suitable device for displaying content to a user, such as a video monitor, television, PDA screen, computer monitor, LCD screen or other component.

Client communication component 110 includes a recorder 112, a processor 114, memory 116 and interface 118. Interface 118 receives and transmits communications between client communication system 110 and a headend or other component. Interface 118 may also receive user instructions for operation of client system 100, such as instructions received from a user remote control or from hard key buttons of client communication component 110. Processor 114 may work alone or in conjunction with other components of client communication component 110, such as memory 116 and recorder 112, to provide the functionality of client communication component 110 described herein. Processor 114 may comprise one or more microprocessors, controllers or any other suitable computing devices or resources. In some embodiments, processor 114 may include a tuner system to extract channels from the signals, such as television signals, received by client communication component 110. Decryptors and decoders may also be included to decode encoded signals for proper processing and display.

Recorder 112, either alone or in conjunction with other components of client communication component 110, records for storage content carried through signals received by client communication component 110. Recorder 112 may comprise one or more microprocessors, controllers or any other suitable computing devices or resources, such as hardware or software, to provide its functionality. Some embodiments may not include a recorder at a client communication component.

Memory 116 may include any form of volatile or nonvolatile memory including, without limitation, magnetic media, optical media, random access memory (RAM), read only memory (ROM), removable media or any other suitable local or remote memory component. In the illustrated embodiment, memory 116 includes recordings 117, which include content received and recorded by client communication component 110, such as television content from a headend. In some cases, recordings 117 may be received by client system 100 as recorded content instead of client system 100 receiving “live” content that is subsequently recorded and stored by recorder 112.

In some embodiments, client communication component 110 may comprise a multi-room system that receives downstream broadband signals from a headend and subsequently provides the downstream signals to a primary device and/or to one or more remote devices for presentation to user(s). The primary and remote devices may be located in different rooms of a home or other building and may be coupled together through any suitable interface, such as coaxial or other cable or wire, telephone lines or wireless interface.

Content provided in signals to client communication component 110 by cable operators, television networks, studios, broadband service providers (such as ISPs) or other content providers may be interspersed with advertisements, commonly referred to as commercials. In some cases the commercials are carefully chosen and aired at times and during programs to help reach targeted audiences. Users of client system 100 may view the content in its recorded form, for example by viewing on display component 120 recordings 117 stored in memory 116.

When viewing recorded content presented on display component 120, users may desire to fast forward through portions of the content, such as the advertisements and commercials interspersed in the content. Processor 114 may receive commands from users to fast forward through content presented on the display. In response to such commands, processor 114 may present on display component 120 the recorded content at a speed that is faster than the speed at which the content is meant to be viewed. Fast forward commands may be received at client system 100 through any suitable type of interface from any suitable component, such as through a wireless interface from a remote control. In particular embodiments, client system 100, through processor 114, may also rewind, pause and present in slower motion content on display component 120 in response to user commands.

In particular embodiments, communications received by client system 100 that include content for presentation to users on display component 120 include data such as closed captioning data, MPEG data (such at MPEG-2 video embedded private data), textual metadata and other data. When content is presented to users by client communication component 110 at a faster than normal speed, processor 114 may read this data and may present, based on the data, textual or other graphical information on display component 120. For example, if a user is fast forwarding through advertisements interspersed in recorded content being displayed, processor 114 may read data embedded in the content to present on display component 120 textual or other graphical information including a brief summary or other information related to the advertisements. Thus, the user will at least briefly be able to see what the commercial is about. As client communication component 110 continues to fast forward the recording and reaches another advertisement, processor 114 reads data associated with the next commercial (such as closed captioning, MPEG or other data) displays information about that next advertisement on display component 120. The net effect is that the user may see information about the commercial, such as a one line highlight of what the commercial is about, as the client communication component skips the video portion of that same commercial.

In some cases, the fast-forwarded recorded program may be faded into the background (e.g., through darkening), and the advertisement summary may be brought to the foreground. With each passing commercial, the advertisement summary list may grow. This enables a viewer to go back to a previous summary if he was slow to get to it. At the end of the commercials, the list of summaries may fade away while the recorded program returns from the background into the foreground.

In some embodiments, special textual or other markers may be inserted at the beginning and end of a particular commercial segment to inform client communication component 110 of the start and end of the commercial segment. Client communication system 110 may thus be configured to automatically skip commercials and just display a one line or more summary for each of the commercials in that segment. The summaries or other information for multiple commercials may be displayed at once on the same screen or on different screens (e.g., with a blank, dark or other background). In some cases, the system may allow a viewer to select a particular line summary (for example, through a remote control or other component) when he sees something interesting. In that case, client communication system 110 may present on display component 120 the corresponding commercial. Otherwise, the viewer may select an option to continue to another commercial summary or to continue on with the show. If the viewer selects to continue with the show, client communication system 110 may start presenting the show when the commercial segment ends by detecting a marker inserted at the end of the commercial segment.

It should be understood that while particular embodiments are illustrated and described as including data for displaying textual or graphical information about advertisement subject matter while fast forwarding through the advertisements, other embodiments may include data for displaying textual or graphical information about content subject matter while fast forwarding through other, non-advertisement portions of content. Thus, the present invention is not limited to the commercial or advertisement context.

As an example in operation, client communication component 110 may receive through interface 118 broadband signals of show content that recorder 112 stores in memory 116 as recordings 117. Processor 114 may work in conjunction with recorder 112 to record such content. The recording of the content may be set or otherwise configured by a user of client system 100.

Assume for purposes of this example that the television show “American Idol” is included in the recorded content. When a viewer is watching the recorded show on display component 120 through client communication component 110, the viewer may press a fast forward button on a remote when he sees that commercials are about to appear in order to skip the commercials. As processor 114 fast forwards through the commercials, the processor presents on display component 120 a one line summary for each passing commercial. Example summaries may include: “Buy one, get one free Big Mac at McDonalds —limited time only,” “All you can rent for $19.99 at Blockbuster” or “20-50% sale at Macy's Children's section.” When the viewer sees the summary regarding the Macy's sale, he may be interested in the sale and may stop the fast forward in order to see the commercial. After the commercial is done, the viewer may continue the fast forward.

Particular embodiments may include variations on the functionality described herein. For example, in some embodiments processor 114 may present on display component 120 at the same time information for more than one commercial in a particular segment of commercials through which the viewer is fast forwarding. In some embodiments, processor 114 may present the viewer with commercial options to select while fast forwarding through the commercials. These may include, for example, an option to view one or more of the commercials or an option to learn more information about the commercials than that being presented on the display during the fast forward process. In some cases, an option may be presented to purchase goods or services being advertised in the commercials. As is the case with the information about the commercials that is presented on the display, instructions regarding the various options for processor 114 to present may be embedded in the signal stream received by client communication component 110 through a headend, satellite system or other component from a cable operator, television network, studio, broadband service provider or other content provider.

FIG. 3 illustrates an example signal 200 received by a client system such as client system 100 of FIG. 2. Signal 200 includes show content portions 210 and advertisement portions 220. Show content portions 210 may include segments of content that a user of the client system desires to record, and advertisement portions 220 may include commercials interspersed in the recorded show content. Signal 200 includes markers 230 which signal the beginnings and endings of the interspersed advertisements, with markers 230a and 230d signaling the beginning and ending, respectively, of the entire commercial segment. The markers may be read by a processor of a client communication component to aid in implementation of the functionality described herein.

Advertisement portions 220 of the signal may include embedded data to instruct a client communication component processor to display information regarding the commercials when a user fast forwards through recorded content of the signal. The markers and the embedded data may be carried in the signal using any appropriate technology, such as closed captioning technology, MPEG technology, textual metadata technology or other suitable technology.

FIGS. 4A and 4B illustrate example screens of a display when particular embodiments are implemented. FIG. 4A illustrates screen 300 as a client communication component fast forwards through commercial 310. Presented on the screen is textual information 320 relating to commercial 310. In some embodiments, a user may be able to select textual information 320 in order to view in normal speed commercial 310 or to perform other tasks, such as purchase of goods advertised in the commercial or provided by the advertiser.

FIG. 4B illustrates screen 400 as a client communication component fast forwards through a segment of multiple commercials 410. In this embodiment, a client communication component processor presents information 420 for three different commercials in the commercial segment at the same time. In some embodiments, a user may be able to highlight or otherwise select information 420a, 420b or 420c in order Lo view in normal speed any of the commercials in the commercial segment or to perform other tasks. Screens 300 and 400 are mere examples of the type of information that may be displayed that is relevant to a particular commercial segment and the manner in which it is displayed, and other embodiments may include other types of information and may display such information in a different manner. For example, in some embodiments graphical information may be displayed rather than or in addition to textual information.

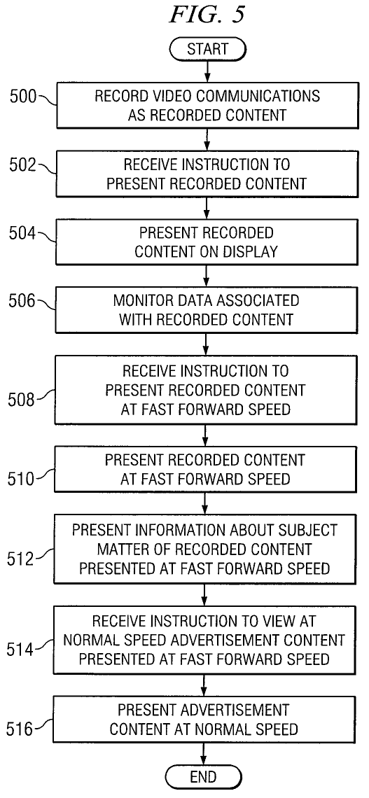

FIG. 5 is a flowchart illustrating a method for presenting information, in accordance with a particular embodiment. The method begins at step 500 where video communications are recorded at, for example, a client communication component. The video communications may include show or movie content interspersed with commercials. At step 502, an instruction is received to present the recorded content on a display, such as a television display. The instruction may be received through any suitable method, such as a wireless remote or preconfiguration. At step 504, the recorded content is presented on the display.

At step 506, data associated with the recorded content is monitored. This data may include, for example, closed captioning data, MPEG data or metadata associated with the video communications received and recorded by a client system. At step 508, an instruction is received, for example from a viewer, to present the recorded content at a fast forward speed on the display. This instruction may be received from a viewer when commercials appear in the playback of the recorded content. In some cases, a client system may be used that automatically fast forwards playback of recorded content when commercials or other particular portions of content are reached in the playback process. In these cases step 508 may occur when the system is configured for such automatic fast forwarding.

At step 510, the recorded content is presented at the fast forward speed. At step 512, information is presented about the subject matter of the recorded content that is presented at the fast forward speed based on the monitored data associated with the recorded content. As an example, if the content presented at the fast forward speed is a commercial, then information about the subject matter of the commercial (such as information about a product or service being advertised) may be presented. This may include textual or graphical information about the commercial subject matter.

At step 514 an instruction is received to view at a normal speed the advertisement content presented at the fast forward speed. For example, a viewer may see textual information presented about a commercial as a client system is fast forwarding through the commercial, and the viewer may want to watch the commercial in normal speed based on the textual information. The viewer may thus use a remote or other component to request playback of the commercial in normal speed. At step 516, the advertisement content is presented at the normal speed.

As discussed above with respect to FIG. 2, in some embodiments textual markers may be used to inform a client communication component of the start and end of a commercial segment. In this case, instead of fast forwarding through commercials of a commercial segment as described with respect to steps 508 and 510, a client communication system may automatically skip commercials and just display a one line or more summary for each of the commercials in that segment. The viewer may be allowed to select a particular line summary (for example, through a remote control or other component) when he sees something interesting.

Some of the steps illustrated in FIG. 5 may be combined, modified or deleted where appropriate, and additional steps may also be added to the flowchart. Additionally, steps may be performed in any suitable order without departing from the scope of the invention.

Although the present invention has been described in detail with reference to particular embodiments, it should be understood that various other changes, substitutions, and alterations may be made hereto without departing from the spirit and scope of the present invention. For example, although particular embodiments have been described with reference to a number of elements included within a client system and a client communication component, these elements may be combined, rearranged or positioned in order to accommodate particular routing architectures or needs. In addition, any of these elements may be provided as separate external components to a client system or client communication component where appropriate. For example, in some cases a recording of received communications may be performed by a separate component. Particular embodiments contemplate great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for presenting information, comprising:
receiving an instruction to present recorded content;
presenting the recorded content on a display;
monitoring data associated with the recorded content;
receiving an instruction to present the recorded content at a fast forward speed;
presenting the recorded content at the fast forward speed on the display; and
while presenting the recorded content at the fast forward speed, presenting on the display information about the subject matter of the recorded content presented at the fast forward speed based on the data associated with the recorded content.

2. The method of claim 1, wherein:
the recorded content presented at the fast forward speed comprises advertisement content; and
the information about the subject matter of the recorded content presented at the fast forward speed comprises information about the advertisement content.

3. The method of claim 2, wherein the information about the subject matter of the recorded content presented at the fast forward speed comprises textual information about the advertisement content.

4. The method of claim 2, wherein the information about the subject matter of the recorded content presented at the fast forward speed comprises graphical information about the advertisement content.

5. The method of claim 2, further comprising:
receiving an instruction to view at a normal speed the advertisement content presented at the fast forward speed; and
presenting on the display the advertisement content at the normal speed.

6. The method of claim 2:
wherein the advertisement content comprises a plurality of advertisements;
wherein presenting on the display information about the subject matter of the recorded content presented at the fast forward speed comprises simultaneously presenting on the display information about the subject matter of each of the plurality of advertisements; and
further comprising:
receiving an instruction to view at a normal speed a selected advertisement of the plurality of advertisements; and
presenting on the display the selected advertisement at the normal speed.

7. The method of claim 1, wherein the data associated with the recorded content comprises closed captioning data.

8. The method of claim 1, wherein the data associated with the recorded content comprises MPEG data.

9. The method of claim 1, further comprising:
receiving communications comprising video content; and
recording the video content as recorded content.

10. The method of claim 9, wherein receiving communications comprising video content comprises receiving communications from a headend or satellite component.

11. A system for presenting information, comprising:
an interface operable to receive an instruction to present recorded content;
a processor coupled to the interface and operable to:
present the recorded content on a display; and
monitor data associated with the recorded content;
the interface further operable to receive an instruction to present the recorded content at a fast forward speed; and
the processor further operable to:
present the recorded content at the fast forward speed on the display; and
while presenting the recorded content at the fast forward speed, present on the display information about the subject matter of the recorded content presented at the fast forward speed based on the data associated with the recorded content.

12. The system of claim 11, wherein:
the recorded content presented at the fast forward speed comprises advertisement content; and
the information about the subject matter of the recorded content presented at the fast forward speed comprises information about the advertisement content.

13. The system of claim 12, wherein the information about the subject matter of the recorded content presented at the fast forward speed comprises textual information about the advertisement content.

14. The system of claim 12, wherein the information about the subject matter of the recorded content presented at the fast forward speed comprises graphical information about the advertisement content.

15. The system of claim 12, wherein:
the interface is further operable to receive an instruction to view at a normal speed the advertisement content presented at the fast forward speed; and
the processor is further operable to present on the display the advertisement content at the normal speed.

16. The system of claim 12:
wherein the advertisement content comprises a plurality of advertisements;
wherein the processor operable to present on the display information about the subject matter of the recorded content presented at the fast forward speed comprises the processor operable to simultaneously present on the display information about the subject matter of each of the plurality of advertisements;
wherein the interface is further operable to receive an instruction to view at a normal speed a selected advertisement of the plurality of advertisements; and
wherein the processor is further operable to present on the display the selected advertisement at the normal speed.

17. The system of claim 11, wherein the data associated with the recorded content comprises closed captioning data.

18. The system of claim 11, wherein the data associated with the recorded content comprises MPEG data.

19. The system of claim 11:
wherein the interface is operable to receive communications comprising video content; and
further comprising a recorder operable to record the video content as recorded content.

20. The system of claim 19, wherein the interface operable to receive communications comprising video content comprises the interface operable to receive communications from a headend or satellite component.

21. Logic embodied in a computer readable medium, the computer readable medium comprising code operable to:
receive an instruction to present recorded content;
present the recorded content on a display;
monitor data associated with the recorded content;
receive an instruction to present the recorded content at a fast forward speed;
present the recorded content at the fast forward speed on the display; and
while presenting the recorded content at the fast forward speed, present on the display information about the subject matter of the recorded content presented at the fast forward speed based on the data associated with the recorded content.

22. The medium of claim 21, wherein:
the recorded content presented at the fast forward speed comprises advertisement content; and
the information about the subject matter of the recorded content presented at the fast forward speed comprises information about the advertisement content.

23. The medium of claim 22, wherein the information about the subject matter of the recorded content presented at the fast forward speed comprises textual information about the advertisement content.

24. The medium of claim 22, wherein the information about the subject matter of the recorded content presented at the fast forward speed comprises graphical information about the advertisement content.

25. The medium of claim 22, wherein the code is further operable to:
receive an instruction to view at a normal speed the advertisement content presented at the fast forward speed; and
present on the display the advertisement content at the normal speed.

26. The medium of claim 22:
wherein the advertisement content comprises a plurality of advertisements;
wherein code operable to present on the display information about the subject matter of the recorded content presented at the fast forward speed comprises code operable to simultaneously present on the display information about the subject matter of each of the plurality of advertisements; and
wherein the code is further operable to
receive an instruction to view at a normal speed a selected advertisement of the plurality of advertisements; and
present on the display the selected advertisement at the normal speed.

27. The medium of claim 21, wherein the data associated with the recorded content comprises closed captioning data.

28. The medium of claim 21, wherein the data associated with the recorded content comprises MPEG data.

29. The medium of claim 21, wherein the code is further operable to:
receive communications comprising video content; and
record the video content as recorded content.

30. The medium of claim 29, wherein code operable to receive communications comprising video content comprises code operable to receive communications from a headend or satellite component.

31. A system for presenting information, comprising:
means for receiving an instruction to present recorded content;
means for presenting the recorded content on a display;
means for monitoring data associated with the recorded content;
means for receiving an instruction to present the recorded content at a fast forward speed;
means for presenting the recorded content at the fast forward speed-on the display; and
means for, while presenting the recorded content at the fast forward speed, presenting on the display information about the subject matter of the recorded content presented at the fast forward speed based on the data associated with the recorded content.

32. A method for presenting information, comprising:
receiving an instruction to present recorded content;
presenting the recorded content on a display;
monitoring data associated with the recorded content;
detecting a first marker in the recorded content;
upon detecting the first marker in the recorded content:
interrupting the presentation of the recorded content; and
presenting on the display information about the subject matter of the recorded content based on the data associated with the recorded content; and
receiving an instruction to continue presentation of the recorded content; and
presenting the recorded content on the display based on detection of a second marker in the recorded content.
